(19) United States
(12) Patent Application Publication
(10) Pub. No.: US 2026/0203097 A1
(43) Pub. Date: Jul. 16, 2026

(54) ASSISTED GPU INITIATED NETWORKING

(71) Applicant: NVIDIA Corporation, Santa Clara, CA (US)

(72) Inventors: Khaled Hamidouche, Austin, TX (US); Manjunath Gorentla Venkata, San Ramon, CA (US); Gil Bloch, Zichron Ya'acov (IL)

(21) Appl. No.: 19/018,650

(22) Filed: Jan. 13, 2025

(51) Int. Cl. G06F 9/48; G06T 1/20

(52) U.S. Cl. CPC G06F 9/4856; G06T 1/20

(57) ABSTRACT

Apparatuses, systems, methods, and techniques to perform graphics processing unit (GPU) initiated networking (GIN). In at least one embodiment, generation of a work queue element (WQE) is offloaded from the GPU to separate hardware (e.g., an accelerator or processor in a network interface controller). In at least one embodiment, the GPU generates a GPU-friendly descriptor (GFD), instead of a WQE, that contains information to create a WQE and transfers the GFD to the separate hardware, which performs the creation of the WQE, processes a completion queue entry (CQE), and provides a notification to the GPU that processing the WQE has been completed.

### TECHNICAL FIELD

At least one embodiment pertains to processors, systems, methods, and/or techniques to perform a Graphics Processor Unit (GPU) initiated data transfer in a computer network. In at least one embodiment, a GPU initiated data transfer requires a number of operations that are to be performed by a processor other than the GPU to thereby offload performance of these operations from the GPU.

### BACKGROUND

GPU Initiated Communication, especially GPU Initiated Networking (GIN), is becoming more widely used to scale out Artificial Intelligence (AI) and high-performance computing (HPC) workloads in multi-processor environments, such as data center systems. GIN is a technique that allows GPUs to directly interact with network interfaces, and in at least some cases, bypass the CPU to achieve lower latency and higher throughput in data transfers. This may be particularly beneficial in high-performance computing, machine learning, and data center environments. However, GIN uses GPU resources to initiate and execute a data transfer. Performance for GIN could be improved within computer networks.

### BRIEF DESCRIPTION OF DRAWINGS

FIG. 1A is a block diagram illustrating a GPU Work Queue (GWQ) process, in accordance with at least one embodiment;

FIG. 1B illustrates a block diagram of an example system to use GWQs to implement GIN, in accordance with at least one embodiment;

FIG. 2 illustrates a block diagram of an example system to implement work queue element (WQE) creation in a network interface controller, in accordance with at least one embodiment;

FIG. 3 is a block diagram illustrating an example processing system, in accordance with at least one embodiment;

FIG. 4A is a flowchart illustrating a method to be performed by a GPU, in accordance with at least one embodiment;

FIG. 4B is a flowchart illustrating a method to be performed by intermediate hardware, in accordance with at least one embodiment;

FIG. 5 is a flowchart illustrating a method to be performed by a network interface controller, in accordance with at least one embodiment;

FIG. 6A illustrates an example of a system that includes a driver and/or runtime including one or more libraries to provide one or more application programming interfaces (APIs), in accordance with at least one embodiment;

FIG. 6B is block diagram illustrating an example of a processor and modules, according to at least one embodiment;

FIG. 7A illustrates logic, according to at least one embodiment;

FIG. 7B illustrates logic, according to at least one embodiment;

FIG. 8 illustrates an example data center system, according to at least one embodiment; and

FIG. 9 is a block diagram illustrating a computer system, according to at least one embodiment.

### DETAILED DESCRIPTION

As described herein, GIN is a technique that allows a GPU to bypass a host CPU and use a network interface controller (NIC) to initiate data transfers to other components and/or devices. For example, a GPU may use GIN to communicate with other GPUs, NICs, storage devices, memory systems, peripheral devices, virtual machines, and/or other components.

Nvidia Collective Communications Library (NCCL) is an example of a communication library that uses GIN to implement communication between multiple GPUs. The GPUs may be components of a single node or multiple different nodes. A node may be a physical computing device (e.g., a computer, a server, a computing device in a cluster, or the like), a network device (e.g., a computer, a router, a switch, or other type of network device), or a logical unit, such as a virtual machine, a container, and/or the like. NCCL may be used, for example, to distribute AI workloads over multiple GPUs on a single node or multiple GPUs on multiple nodes. GIN-centric libraries, like Nvidia Shared Memory (NVSHMEM) library, may be used to design distributed fused computation and communication kernels like distributed general matrix multiply (GEMM) provided in cuBlasMp library (used in Tensor Parallelism for AI workloads). GIN may be used to distribute computations, such as those used to implement machine learning, across multiple processors and/or devices. GIN may be used by GPUs that include a GPU DMA to accelerate asynchronous communication from one or more streaming multiprocessors (SM(s)). The SM(s) may asynchronously issue requests to the GTA to perform communication operations over a GPU-to-GPU communication network, such as NVLINK.

GIN involves creating a Work Queue Element (WQE) (e.g., at a GPU), and processing a Completion Queue Entry (CQE) (e.g., at a NIC). The WQE is a data structure created by an application (e.g., using a kernel, such as a CUDA kernel) and used to describe one or more network operations (e.g., a send operation or a receive operation) to be performed by a network interface controller (NIC). In at least one embodiment, the CQE is a data structure created by the NIC and used to notify the application when the network operation(s) described by the WQE is/are finished.

While a GPU may implement GIN using a proxy-based approach in which the GPU requests a CPU thread to perform the network communication on behalf of the GPU, this approach may have some limitations. For example, scalability may be limited because multiple CPU threads might be required to handle the requests coming from GPUs. Additionally, the proxy-based approach may result in high latency due to synchronization required between the CPU and the GPU.

Another approach, referred to as a GPU-Verbs approach, removes the CPU from the critical path of the interaction between the GPU and the NIC. Instead, a SM of the GPU directly creates a WQE (e.g., including network descriptors), posts the WQE in a work queue (e.g., a send queue or a receive queue of a queue pair (QP)) in GPU memory, and notifies the NIC that a new WQE has been posted in the work queue (e.g., rings the NIC's doorbell). This approach provides parallelism because multiple GPU threads can directly talk to the NIC in parallel. However, it negatively affects the occupancy of (e.g., use of data registers by) the GPU kernel. In fused computation-communication kernels where the compute kernel is directly initiating communication, the compiler may process the communication calls inline directly in the compute kernel. As the communication function creates the WQE, the communication function may require a lot of registers because the format of the WQE may be complex. Taking registers away from the compute function significantly affects the occupancy and hence decreases the performance of the GPU. Additionally, communicating using WQEs may involve a number of memory fences including a memory fence in the critical path of communication between the GPU and the NIC. Such memory fences help ensure correct ordering of memory operations and/or visibility of the memory operations between the GPU and the NIC. For example, the GPU creates a memory fence around the WQE, and must send a notification to the NIC (e.g., referred to as ringing a doorbell) that the WQE is available for processing. Memory fences may negatively impact performance of the GPU.

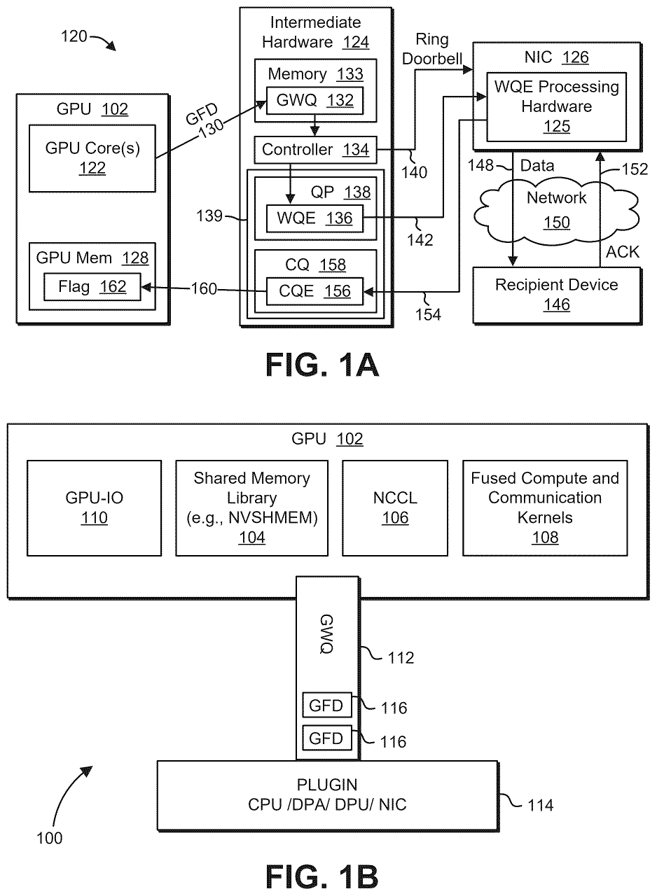

FIG. 1A is a block diagram illustrating a GPU Work Queue (GWQ) process 120, in accordance with at least one embodiment. The GWQ process 120 may implement GIN between at least one producer of data (e.g., one of GPU core(s) 122) and at least one consumer of the data (e.g., a NIC 126). In at least one embodiment, the GWQ process 120 accommodates multiple consumers and may have a single or multiple producers. At least a portion of the GWQ process 120 may be performed by one of the GPU core(s) 122, intermediate hardware 124, and/or the NIC 126. Referring to FIG. 1A, in at least one embodiment, the GPU core(s) 122, the intermediate hardware 124, and/or the NIC 126 may perform the GWQ process 120 instead of using the proxy-based approach or the GPU-Verbs approach. In at least one embodiment, the GPU core(s) 122, the intermediate hardware 124, and/or the NIC 126 may perform the GWQ process 120 in addition to using the proxy-based approach and/or the GPU-Verbs approach. The GPU core(s) 122 are components of a GPU 102, which may include or be associated with GPU memory 128. In at least one embodiment, another type of parallel processing unit (PPU) associated with local memory may be used in place of the GPU 102 and the GPU memory 128, respectively. In such embodiments, one or more processing units (e.g., core(s)) of the PPU are used in instead of and in place of the GPU core(s) 122.

In at least one embodiment, the intermediate hardware 124 may be characterized as assisting the GPU 102 (e.g., one of GPU core(s) 122) with creation one or more WQEs (e.g., a WQE 136). The intermediate hardware 124 may be any hardware positioned to communicate with the GPU core(s) 122 of the GPU 102, and WQE processing hardware 125 (e.g., a direct memory access (DMA) controller, a DMA interface, or at least one processor) of the NIC 126. For example, the intermediate hardware 124 may be a component of the GPU 102, the NIC 126, a host CPU (not shown), and/or any other hardware component positioned to communicate with both the GPU core(s) 122, and the WQE processing hardware 125 of the NIC 126. By way of non-limiting examples, the intermediate hardware 124 may be a DPA of the NIC 126, a DPU of the NIC 126, an accelerator of the NIC 126, an accelerator of the GPU 102, and/or another hardware component of the NIC 126 and/or GPU 102. In at least one embodiment, the intermediate hardware 124 (e.g., a data-path accelerator (DPA) or hardware other than the GPU core(s) 122) assists in the creation and handling of network operations. In addition to improving GPU network performance, the GWQ process 120 may be used to unify programming abstraction between a GPU-to-GPU link system (e.g., GPU networking, such as that implemented by NVLINK) and the NIC 126.

When one of the GPU core(s) 122 has data to transmit using the NIC 126, the GPU core stores a GPU-friendly descriptor (GFD) 130 in a GWQ 132 in memory 133. The memory 133 is a component of or is accessible by a controller 134 of the intermediate hardware 124. The controller 134 detects the GFD 130 has been stored in the GWQ 132, for example, by polling the GWQ 132, receiving a notification from the GWQ 132, receiving a notification from the GPU core indicating that the GFD 130 has been stored in the GWQ 132, and/or making this determination in another manner. The stored GFD 130 may function as or provide a Push interface from the GPU core that created the GFD 130 to the NIC 126. Storing the GFD 130 in the GWQ 132 replaces ringing the doorbell, and the GPU core sends the GFD 130 to the GWQ 132 instead of creating a WQE. The GFD 130 includes all of the parameter values necessary to create a WQE, such as source address, destination address, operation type (e.g., write, read, atomic write, atomic read, etc.), and a completion address pointer. In at least one embodiment, the GFD 130 includes a size indicator identifying a size of the data to be transferred. The source address identifies a storage location of data to be transmitted to the destination address (e.g., the recipient device 146). The completion address pointer identifies a memory location in the GPU memory 128 where a value of a flag 162 will be updated to indicate the data has been transferred. At least a portion of the parameter values included in the GFD 130 may have been provided by a user, and/or automatically generated by a kernel (e.g., a CUDA kernel).

In response to receiving the GFD 130, the controller 134 obtains the GFD 130 from the GWQ 132, creates a WQE 136, and stores the WQE 136 in a QP 138 in memory accessible to both the controller 134 and the NIC 126. In at least one embodiment, the QP 138 is stored in the memory 133. In at least one embodiment, the QP 138 is stored in memory 139 which may a component of or separate from the memory 133. Then, the controller 134 sends a notification 140 to (rings the doorbell of) the WQE processing hardware 125 (e.g., a DMA controller, a DMA interface, at least one processor, and/or another component) in the NIC 126. In response to the notification 140, the WQE processing hardware 125 of the NIC 126 fetches (illustrated as arrow 142) and processes the WQE 136. In this example, the WQE 136 is a request to send (e.g., identified by the operation type of the GFD 130) data (e.g., stored in the source address of the GFD 130) to a recipient device 146 (e.g., at the destination address of the GFD 130). The WQE processing hardware 125 of the NIC 126 obtains the data in accordance with the WQE 136, and uses a destination address included in the WQE (e.g., obtained from the GFD 130) to transmit (illustrated as arrow 148) the data to the recipient device 146 over a network 150. After the recipient device 146 receives that data, the recipient device 146 sends an acknowledgement (ACK) 152 to the NIC 126. After receiving the ACK 152, the WQE processing hardware 125 of the NIC 126 creates a CQE 156 and pushes (illustrated as arrow 154) the CQE 156 to a CQ 158, for example, indicated by an identifier of the CQ 158 included in the WQE 136. The CQ 158 is stored in memory (e.g., the memory 133 and/or the memory 139) accessible to both the controller 134 and the NIC 126. After receiving the CQE 156, the controller 134 updates (illustrated as arrow 160) a flag 162 in the GPU memory 128. The address of the flag 162 may have been indicated by the completion address pointer obtained from the GFD 130. The GPU core may poll the flag 162 to determine when the operation indicated by the WQE 136 has been completed. For example, the GPU 102 may set the value of the flag 162 to FALSE before sending or pushing the GFD 130 to the GWQ 132 (e.g., when allocating the flag 162), and the controller 134 may update the value of the flag 162 to TRUE in response to receiving the CQE 156.

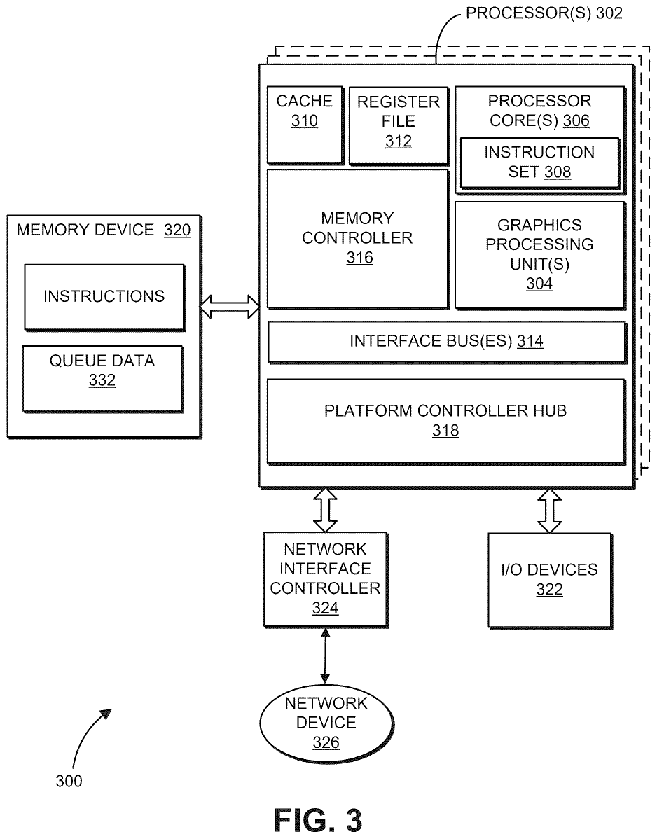

In at least one embodiment, the GPU core(s) 122 each include or have access to a non-transitory machine-readable media (e.g., the GPU memory 128) storing instructions, that when performed by the GPU core(s) 122, cause the GPU 102 to at least generate the GFD 130, store the GFD 130 in the GWQ 132, and detect (e.g., using polling) when the flag 162 has been updated. In at least one embodiment, at least a portion of the GPU 102 and/or a portion of one or more of the GPU core(s) 122 is implemented using at least a portion of any system(s) depicted in and/or described with respect to FIGS. 3 and 6-9. In at least one embodiment, at least a portion of the GPU 102 and/or a portion of one or more of the GPU core(s) 122 is used to implement at least a portion of any system(s) depicted in and/or described with respect to FIGS. 3 and 6-9. By way of additional non-limiting examples, the GPU memory 128 (e.g., one or more non-transitory processor-readable medium) may be implemented, for example, using volatile memory (e.g., dynamic random-access memory (“DRAM”)) and/or nonvolatile memory (e.g., a hard drive, a solid-state device (“SSD”), and/or the like). In at least one embodiment, at least a portion of the GPU memory 128 is implemented using at least a portion of any system(s) depicted in and/or described with respect to FIGS. 3 and 6-9. In at least one embodiment, at least a portion of the GPU memory 128 is used to implement at least a portion of any system(s) depicted in and/or described with respect to FIGS. 3 and 6-9.

In at least one embodiment, the intermediate hardware 124 may include or have access to a non-transitory machine-readable media (e.g., the memory 133 and/or the memory 139) storing instructions, that when performed by the controller 134, cause the intermediate hardware 124 to at least obtain the GFD 130 from the GWQ 132, generate the WQE 136, detect receipt of the CQE 156, and update the flag 162. These instructions may also cause the intermediate hardware 124 to send the notification 140, and/or receive the CQE 156. The controller 134 may include one or more circuits that perform at least a portion of the instructions (e.g., stored in the memory 133 and/or the memory 139). The controller 134 may include one or more parallel processing units (“PPU(s)”), such as one or more graphics processing units (“GPU(s)”), one or more massively parallel GPU(s), and/or the like. In at least one embodiment, massively parallel GPU(s) refer to a collection of one or more GPUs, or any suitable processing units, which may be utilized to perform various processes in parallel. The controller 134 may be implemented, for example, using a main central processing unit (“CPU”) complex, one or more microprocessors, one or more microcontrollers, the PPU(s) (e.g., GPU(s)), one or more data processing units (“DPU(s)”), one or more arithmetic logic units (“ALU(s)”), and/or one or more other types of processors and/or accelerators. In at least one embodiment, at least a portion of the controller 134 is implemented using at least a portion of any system(s) depicted in and/or described with respect to FIGS. 3 and 6-9. In at least one embodiment, at least a portion of the controller 134 is used to implement at least a portion of any system(s) depicted in and/or described with respect to FIGS. 3 and 6-9.

By way of additional non-limiting examples, the memory 133 and/or the memory 139 (e.g., one or more non-transitory processor-readable medium) may be implemented, for example, using volatile memory (e.g., DRAM) and/or nonvolatile memory (e.g., a hard drive, a SSD, and/or the like). In at least one embodiment, at least a portion of the memory 133 and/or the memory 139 is implemented using at least a portion of any system(s) depicted in and/or described with respect to FIGS. 3 and 6-9. In at least one embodiment, at least a portion of the memory 133 and/or the memory 139 is used to implement at least a portion of any system(s) depicted in and/or described with respect to FIGS. 3 and 6-9.

In at least one embodiment, the WQE processing hardware 125 of the NIC 126 may include or have access to a non-transitory machine-readable media storing instructions, that when performed by the WQE processing hardware 125 (e.g., at least one processor), cause the NIC 126 to at least obtain the WQE 136, process the WQE 136, generate the CQE 156, and store the CQE 156 in the CQ 158. These instructions may also cause the WQE processing hardware 125 of the NIC 126 to obtain the data, send the data to the recipient device 146, and receive the ACK 152 from the recipient device 146. By way of additional non-limiting examples, the non-transitory machine-readable media may be implemented, for example, using volatile memory (e.g., DRAM) and/or nonvolatile memory (e.g., a hard drive, a SSD, and/or the like). In at least one embodiment, the WQE processing hardware 125 includes at least one processor to execute the instructions. The processor(s) of the WQE processing hardware 125 may be implemented using any device suitable for implementing the controller 134. In at least one embodiment, at least a portion of the NIC 126 and/or the WQE processing hardware 125 is implemented using at least a portion of any system(s) depicted in and/or described with respect to FIGS. 3 and 6-9. In at least one embodiment, at least a portion of the NIC 126 and/or the WQE processing hardware 125 is used to implement at least a portion of any system(s) depicted in and/or described with respect to FIGS. 3 and 6-9.

FIG. 1B illustrates a block diagram of an example system 100 to use GWQs to implement GIN, in accordance with at least one embodiment. In the system 100, the GPU 102 is a producer of data and communications requests. In at least one embodiment, the GPU 102 includes or accesses libraries that implement communications software customized for GPU communications. In at least one embodiment, these libraries include a shared memory library 104 (e.g., NVSHMEM) that provides a parallel programming interface for efficient communication between multiple GPUs (e.g., the GPU 102 and at least one other GPU). In at least one embodiment, these libraries include a collective communications library 106 (e.g., NCCL) that provides optimized communication primitives for communication in multi-GPU and multi-node systems. In at least one embodiment, the GPU 102 performs one or more combined or fused compute and communications functions 108 (e.g., one or more kernels, such as one or more CUDA kernels) to operations on data. The fused compute and communications function(s) 108 implements a technique in which one or more computational processes are combined with one or more communications processes to permit the transfer of data between processors while simultaneously performing data processing operations on the data.

In at least one embodiment, the GPU 102 includes a GPU-IO 110 that controls input and output (I/O) operations for the movement of data between the GPU 102 and the GPU memory 128 (see FIG. 1A) and between the GPU 102 and other components, such as processors. In at least one embodiment, the GPU 102 initiates network communications with other devices (e.g., the recipient device 146) on a network (e.g., the network 150), such as other GPUs, one or more CPUs, one or more DPUs, one or more data-path accelerators (DPA(s)), one or more processors, one or more accelerators, one or more computing devices, one or more virtual machines, one or more containers, one or more other types of hardware components, and/or one or more other types of virtual components.

A GWQ 112 is a software abstraction of a queue for communications between the GPU 102 and one or more consumers (e.g., the NIC 126). The GPU core that created the GFD 130 may use the GFD 130 and the GWQ 112 as a push interface to such consumer(s), such as the NIC 126. In at least one embodiment, the GWQ 112 may be a software abstraction of a queue for the push interface enabling GPU initiated communication with consumer(s), such as the NIC 126. In FIG. 1B, the GWQ 112 may be implemented by or for one or more consumers using a network plug-in 114 that can be implemented by CPU(s), DPA(s), DPU(s), NIC(s), one or more processors, one or more accelerators, at least one other type of hardware, and/or one or more virtual machines. For example, the network plug-in 114 may be implemented as instructions stored on a non-transitory machine-readable media, and the instructions when performed by at least one processor (e.g., the controller 134) may implement the GWQ 112. By way of another non-limiting example, the network plug-in 114 may be implemented as instructions stored on a non-transitory machine-readable media, and the instructions when performed by at least one processor (e.g., the controller 134) may perform at least a portion of the GWQ process 120 (see FIG. 1A).

An instance of GWQ 112 may be implemented per-descriptor (e.g., per GFD 116) with local completion, and permits a user to associate pointers for each descriptor. In addition, a counter/flag-based remote completion indicator (e.g., the flag 162) can be combined with the completion signal (e.g., the CQE 156) to reduce latency. In at least one embodiment, the GPU 102 initiates network communication (e.g., GIN) with the creation of one or more GFDs 116 instead of creating a WQE. In at least one embodiment, the GPD(s) 116 each includes all of the parameter values necessary for a separate processor (e.g., the controller 134) to create a WQE (e.g., the WQE 136) and to process a CQE (e.g., the CQE 156).

The system 100 may reduce (e.g., minimize) occupancy impact, and/or latency, and/or improve scalability of GIN by offloading the task of creating the WQE (e.g., the WQE 136) and processing the CQE (e.g., the CQE 156) to a hardware processor (e.g., the controller 134) other than the GPU core(s) 122.

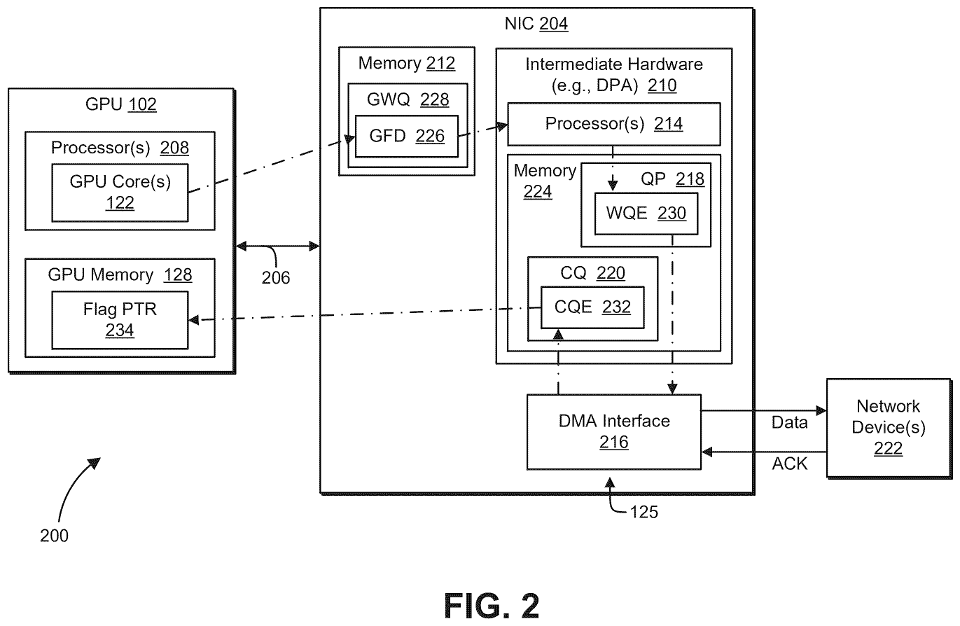

FIG. 2 illustrates a block diagram of an example system 200 to implement WQE creation in a NIC 204, in accordance with at least one embodiment. The system 200 may be implemented using the system 100 (see FIG. 1B). The system 200 may be used to implement the GWQ process 120 (see FIG. 1A). In at least one embodiment, illustrated in FIG. 2, the system 200 includes the GPU 102 coupled to the NIC 204 via one or more communication links 206. In at least one embodiment, the communication link(s) 206 may be implemented as part of an internal data bus when the NIC 204 is implemented as a card or a printed circuit board that is connected to (e.g., plugged into) the communication link(s) 206, which are connected to the GPU 102. Alternatively, the communication link(s) 206 may be implemented as a data cable if the NIC 204 is implemented as an external device with respect to the GPU 102. In at least one embodiment, the communication link(s) 206 may be implemented as a connection, a bus, a Peripheral Component Interconnect Express (“PCIe”) link (or bus), and/or the like. In at least one embodiment, at least a portion of the communication link(s) 206 is implemented using at least a portion of any system(s) depicted in and/or described with respect to FIGS. 3 and 6-9. In at least one embodiment, at least a portion of the communication link(s) 206 is used to implement at least a portion of any system(s) depicted in and/or described with respect to FIGS. 3 and 6-9.

In at least one embodiment, the GPU 102 includes one or more processors 208 that each include one or more of the GPU core(s) 122 (e.g., CUDA core(s)). In at least one embodiment, at least a portion of the processor(s) 208 are each implemented as a streaming multiprocessor (SM). In at least one embodiment, the GPU 102 includes or has access to the GPU memory 128. In at least one embodiment, the GPU memory 128 may be implemented at least in part as a high-bandwidth memory (HBM). In at least one embodiment, the GPU 102 may include other components relevant to graphics data processing, machine learning, and/or other tasks.

The NIC 204 may be implemented using the NIC 126 (see FIG. 1A). The NIC 204 includes at least intermediate hardware 210, memory 212, and the WQE processing hardware 125. In FIG. 2, the WQE processing hardware 125 includes a direct memory access (DMA) interface 216 and may include one or more components of the intermediate hardware 210, such as a controller or processor 214 and memory 224. In at least one embodiment, the NIC 204 may be implemented as an integrated circuit (IC) with the memory 212, the intermediate hardware 210, and the WQE processing hardware 125 (e.g., the DMA interface 216) integrated into a single chip. In at least one embodiment, the memory 212 may be implemented as a memory integrated circuit (MEMIC). The memory 212 may store a GWQ 228.

The intermediate hardware 210 may be an implementation of the intermediate hardware 124. In at least one embodiment, the intermediate hardware 210 may implement a DPA to assist in the creation and handling of network operations. The intermediate hardware 210 may include the processor 214 and the memory 224. Both the memory 212 and the memory 224 may be considered local memory with respect to the NIC 204. The memory 224 may be considered local memory with respect to the intermediate hardware 210. The memory 212 and the memory 224 may each occupy portions of a common memory device and/or may be parts of a common or shared memory. The memory 224 may be a component of the memory 212, or vice versa. The memory 224 may store a queue pair (QP) 218, and a completion queue (CQ) 220. In one embodiment, the QP 218 is implemented as a set of two separate queues, one for sending data and one for receiving data, used to manage communication between two network devices (e.g., between the GPU 102 and at least one of other network device(s) 222). The DMA interface 216 provides direct memory access for data transfers between the NIC 204 and other network device(s) 222.

In at least one embodiment, a GIN request is initiated by the creation of a GFD 226 by the GPU 102. The GPU 102 stores the GFD 226 in the memory 212 of the NIC 204 (via the communication link(s) 206). The processor 214 of the intermediate hardware 210 detects the GFD 226 in the GWQ 228, uses the GFD 226 to generate a WQE 130, and stores the WQE 230 in the QP 218. The WQE 230 is a data structure created by an application (e.g., the network plug-in 114) that is used to describe one or more network operations (e.g., a send operation or a receive operation) to be performed by a network interface controller (e.g., the NIC 204). In at least one embodiment, the task of creating the WQE 230 is handed off to a processor (e.g., the processor 214) other than the processor(s) 208 (e.g., other than the GPU core(s) 122). In at least one embodiment, the processor (e.g., the processor 214) that creates the WQE 230 may be in the NIC 204 (e.g., a component of the intermediate hardware 210). Because the NIC 204 is ultimately responsible for processing the WQE 230, it may be more efficient to have the intermediate hardware 210 (e.g., a DPA) in the NIC 204 perform the task of creating the WQE 230. However, the processor given the task of creating the WQE 230 may be located in another hardware component, such as a separate processor and/or accelerator within a CPU (e.g., the processor 902 of FIG. 900), or even a separate processor and/or accelerator within the GPU 102 other than the GPU core(s) 122. Offloading creation of the WQE 230 from the processor(s) 208 and/or the GPU core(s) 122 may help improve the performance of the GPU 102.

In at least one embodiment, the WQE processing hardware 125 (e.g., the hardware processor 214) performs the task of creating the CQE 232 and/or deleting the corresponding WQE 230 from the QP 218. The CQE 232 is used to notify the application (e.g., the function or kernel executing on the GPU 102) when the network operation(s) described by the WQE 230 is/are successfully completed. In at least one embodiment, after the CQE 232 is stored in the CQ 220, the processor 214 detects the CQE 232 and sends a completion indicator to the GPU 102 by setting a flag 234 in an address identified by a completion address pointer. In at least one embodiment, the completion address pointer points to a location in the GPU memory 128. The GPU 102 monitors its the GPU memory 128 (e.g., using polling) to detect that the flag 234 has been updated (e.g., has been set to TRUE).

In at least one embodiment, the GPU 102 creates the GFD 226 instead of creating the WQE 230. The GFD 226 includes all parameters necessary to create the WQE 230. For example, the GFD 226 may include any of the parameter values discussed herein, with respect to GFD 116 or GFD 130, including source address(es), destination address(es), operation type, and a completion address pointer. In at least one embodiment, the GPU 102 initiates a GIN transfer by posting the GFD 226 to the memory 212 in the NIC 204. For example, one of the processor(s) 208 within the GPU 102 may initiate the GIN transfer by posting or pushing the GFD 226 directly to the GWQ 228 in the memory 212 in the NIC 204. In at least one embodiment, posting the GFD 226 functions as notification to the hardware processor 214 (e.g., of a DPA) and the GFD 226 itself may include any information included in a doorbell ring. This eliminates the requirement of a doorbell ring and reduces latency associated with the doorbell ringing process. The inclusion of such information in the GFD 226 may consolidate memory access operations between the GPU 102 and the memory 212 in the NIC 204. This ensures that only a single PCIe access is performed (e.g., over the communication link(s) 206) between the GPU 102 and the memory 212 to post the GFD 226, which further reduces latency.

In at least one embodiment, a thread in the hardware processor 214 of the NIC (e.g., of a DPA) polls the memory 212 to detect the new GFD 226 posted to the GWQ 228 by the GPU 102. In response, the hardware processor 214 begins transforming the GFD 226 into the WQE 230. In at least one embodiment, the processor 214 may use metadata to generated the WQE 230 based upon the GFD 226. Such metadata may be stored by a thread performed by the intermediate hardware 210 (e.g., a DPA) in local memory (e.g., the memory 212).

In at least one embodiment, the interaction between the GPU 102 and the NIC 204 may be characterized by at least the following five steps. In a first step, the GPU 102 directly creates and posts the GFD 226 to the GWQ 228 in the NIC memory 212. By way of a non-limiting example, the GPU 102 may use one of the fused compute and communications function(s) 108 and/or another operation to create and post the GFD 226. In at least one embodiment, a low-latency protocol is used in which notification of the processor 214 of the available GFD 226 is part of the GFD 226. This eliminates the need for a doorbell ring and the associated latency. In at least one embodiment, data accesses from the GPU 102 to the NIC 204 are reduced or minimized. In at least one embodiment, all necessary information required to create the WQE 230 are contained within the GFD 226 so that only one PCIe transaction is performed between the GPU 102 and NIC 204 to post the GFD 226. In at least one embodiment, one of the processor(s) 208 (e.g., a SM) in the GPU 102 creates and communicates the GFD 226 to the local memory 212 in the NIC 204.

In a second step, the processor 214 (e.g., performing instructions included in the network plug-in 114) detects the GFD 226, and uses the GFD 226 to generate the WQE 230. In at least one embodiment, a thread (e.g., a DPA thread) in the processor 214 polls the NIC memory 212 to detect the new GFD 226 posted by the GPU 102 and uses the GFD 226 to generate the WQE 230. Generating the WQE 230 may require some metadata, but the thread (e.g., the DPA thread) may have or access any necessary metadata already stored in the NIC local memory 212 and/or the memory 224. In at least one embodiment, the WQE 230 created by the processor 214 is stored in the NIC local memory 212 and/or the memory 224.

In a third step, the processor 214 (e.g., performing instructions included in the network plug-in 114) posts the WQE 230 in the QP 218. In at least one embodiment, a thread (e.g., a DPA thread) performed by the processor 214 posts the WQE 230 to the appropriate work queue (e.g., a send queue) of the QP 218 allowing the NIC 204 to perform any operations specified by the WQE 230 (e.g., transmitting data from a buffer to other network device(s) 222 in a network, such as the network 150 illustrated in FIG. 1A). The thread (e.g., the DPA thread) performed by the processor 214 allocates any necessary data structures, including the QP 218 and doorbell, in the local memory 212 and/or the memory 224, which provides low latency access from the processor 214. Because the WQE 230 is stored in the local memory 212 and/or the memory 224, it is not necessary for the WQE processing hardware 125 to perform a PCIe operation to fetch the WQE 230 from the GPU 102 (or the CPU in the proxy-based approach). This further reduces latency. In at least one embodiment, the WQE processing hardware 125 of the NIC 204 uses DMA capabilities of the DMA interface 216 to communicate with the other network device(s) 222 over the network (e.g., the network 150 illustrated in FIG. 1A).

In a fourth step, the WQE processing hardware 125 of the NIC 204 (e.g., the DMA interface 216) generates the CQE 232 and posts the CQE 232 in the CQ 220. For example, the NIC 204 (e.g., the DMA interface 216) may transmit data to at least one of the network device(s) 222, and receive an ACK back from the network device(s) 222 indicating the data was received. Then, in response to receiving the ACK, the WQE processing hardware 125 of the NIC 204 (e.g., the DMA interface 216) may generate the CQE 232 and post the CQE 232 in the CQ 220. In at least one embodiment, the NIC 204 transmits the data to a second computing device (e.g., a selected one of the network device(s) 222) which response with an ACK indicating the data was received. The processor 214 (e.g., performing instructions included in the network plug-in 114) detects and processes the CQE 232. For example, the WQE processing hardware 125 of the NIC 204 (e.g., the DMA interface 216) may notify the processor 214 (e.g., performing instructions included in the network plug-in 114) that the CQE 232 has been posted or the processor 214 may poll the CQ 220 for new CQEs. The intermediate hardware 210 of the NIC 204 processes the CQE in the CQ 220, which triggers a thread (e.g., a DPA thread) performed by the processor 214 and associated with the CQ to process the CQE. During this process, the thread (e.g., the DPA thread) will look up the GPU flag pointer, which is or was included in the posted GFD 226.

In a fifth step, the processor 214 (e.g., performing instructions included in the network plug-in 114) updates the flag 234 to notify the GPU 202 that the GFD 226 has been processed. In at least one embodiment, a thread performed by the processor 214 (e.g., a DPA thread) notifies the GPU 102 about the completion of the operation(s) described by the GFD 226 by writing a completion value (e.g., a flag) directly to an address in the GPU memory 128 pointed to or indicated by the completion address pointer (or GPU flag pointer). To reduce the number of PCIe transactions, the GPU 102 polls only its local memory (e.g., the GPU memory 128) to detect the completion value.

By moving the creation of the WQE 230 to a processor (e.g., the processor 214 in the NIC 204) other than the processor(s) 208, the register occupancy problem in the GPU 102 may be eliminated, and/or a number of PCIe transactions (ideally a single PCIe transaction) reduced, which reduces latency. The completion notification via the pointer (e.g., the completion address pointer) provided in the GFD 226 may reduce latency by eliminating CQE processing by the processor(s) 208 of the GPU 102.

In at least one embodiment, the intermediate hardware 210 may include or have access to a non-transitory machine-readable media (e.g., the memory 212 and/or the memory 224) storing instructions (e.g., included in the network plug-in 114), that when performed by the processor 214, cause the intermediate hardware 210 to at least obtain the GFD 226 from the GWQ 228, generate the WQE 230, detect receipt of the CQE 232, and update the flag 234. These instructions may also cause the intermediate hardware 210 to ring the doorbell of the WQE processing hardware 125 of the NIC 204, and/or receive the CQE 232. The processor 214 may include one or more circuits that perform at least a portion of the instructions (e.g., stored in the memory 212 and/or the memory 224). The processor 214 may be implemented using any device suitable for implementing the controller 134. In at least one embodiment, at least a portion of the processor 214 is implemented using at least a portion of any system(s) depicted in and/or described with respect to FIGS. 3 and 6-9. In at least one embodiment, at least a portion of the processor 214 is used to implement at least a portion of any system(s) depicted in and/or described with respect to FIGS. 3 and 6-9.

In at least one embodiment, the WQE processing hardware 125 of the NIC 204 may include or have access to a non-transitory machine-readable media (e.g., the memory 212 and/or the memory 224) storing instructions, that when performed by the WQE processing hardware 125 (e.g., at least one processor), cause the WQE processing hardware 125 of the NIC 204 to at least obtain the WQE 230, process the WQE 230, generate the CQE 232, and store the CQE 232 in the CQ 220. These instructions may also cause the WQE processing hardware 125 of the NIC 204 to obtain data associated with the WQE 230 (e.g., identified by the WQE 230), send the data to at least one of the network device(s) 222, and receive an ACK 152 the network device(s) 222. In at least one embodiment, at least a portion of the WQE processing hardware 125 and/or the NIC 204 is implemented using at least a portion of any system(s) depicted in and/or described with respect to FIGS. 3 and 6-9. In at least one embodiment, at least a portion of the WQE processing hardware 125 and/or the NIC 204 is used to implement at least a portion of any system(s) depicted in and/or described with respect to FIGS. 3 and 6-9.

As noted above, the GPU 102 initiates network communications with the creation of the GFD 226 on the GWQ 228. In at least one embodiment, the push interface, which involves creating the GFD 226, is low latency and reduces a number of instructions performed and/or registers used by the GPU 102 compared with the creation of the WQE 230 by the GPU 102 itself. In at least one embodiment, the process of creating the GFD 226 also reduces the number of memory fences compared with creating the WQE 230 using the GPU 102, and/or eliminates the memory fence positioned in the critical path between the GPU 102 and the NIC 204. In addition, the use of the GFD 226 results in lower consumption of bandwidth and less of remote fetching (RF) because only information provided by a user may be passed using the GFD 226 onto the network (e.g., the network 150). In at least one embodiment, the GFD 226 includes only source (e.g., source address), destination (e.g., destination address), size, operation (e.g., operation type), and CQE pointer (e.g., completion address pointer).

In at least one embodiment, the GFD 226, with all necessary information to create the WQE 230, allows the PCIe transfer (e.g., across the communication link(s) 206) to be reduced to a single transaction between the GPU 102 and the NIC 204. The transaction includes the information in the GFD 226 needed for the processor 214 (e.g., within a DPA) in the NIC 204 to create the WQE 230. Furthermore, the GFD protocol may include a notification to the NIC 204 that a new GFD is available in the GWQ 228. A thread (e.g., a DPA thread) performed by the processor 214 may poll the NIC memory 212 to detect the new GFD posted by the GPU 102.

The processor 214 in the NIC 204 transforms the GFD transaction on the fly into the WQE 230 and rings the doorbell of the WQE processing hardware 125 of the NIC 204 (e.g., the DMA interface 216) to trigger the transfer of data to another computing device (e.g., a selected one or more of the network device(s) 222).

In at least one embodiment, it is efficient to use the processor 214 (e.g., the DPA) in the NIC 204 to create WQEs because the NIC 204 will perform operation(s) specified by the WQEs and any data involved will ultimately be routed to the NIC 204 for transmission to other portions of the network (e.g., the network device(s) 222). In at least one embodiment, the WQE 230 can be created by a hardware component other than the DPA in the NIC 204. For example, the WQE 230 can be created by at least one processor other than the host CPU (e.g., processor cores 306 in FIG. 3) or the GPU core(s) 122 of the GPU 102. In one embodiment, the GPU 102 may contain one or more circuits and/or one or more hardware components (e.g., one or more processors) other than the processor(s) 208 and/or the GPU core(s) 122 to perform the WQE creation task. In addition, the processor 214 processes the CQE 232 to send a completion indicator to the GPU 102 that initiated the network request.

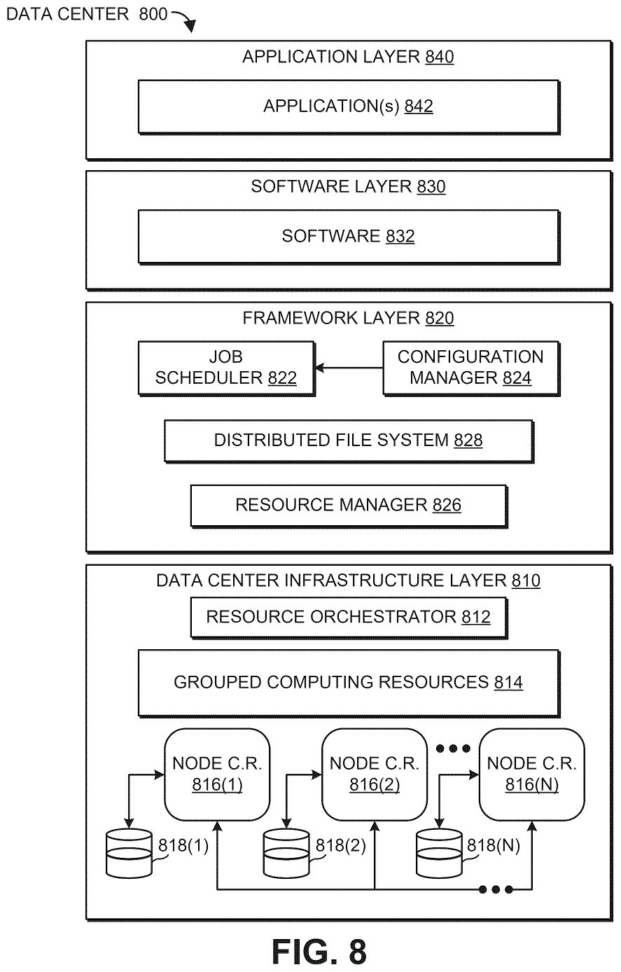

FIG. 3 is a block diagram illustrating an example processing system 300, in accordance with at least one embodiment. In at least one embodiment, the processing system 300 that may be used to implement a data center (e.g., the data center 800 of FIG. 8) or other computing environment in which multiple users operate computing devices (e.g., processor(s) 302) that communicate with the processing system 300 over the internal and/or external networks.

In at least one embodiment, the processing system 300 includes one or more processors 302 and one or more graphics processing units (“GPU(s)”) 304, and may be a single processor desktop system, a multiprocessor workstation system, or a server system having a large number of processor(s) 302 and/or processor cores 306. For example, the processing system 200 may implement one or more computing devices, a data center, a cloud computing system, and/or the like. In at least one embodiment, the processors core 306 is referred to as a computing unit or compute unit.

In at least one embodiment, the processor(s) 302 each include one or more processor cores 306 to process instructions which, when executed, perform operations for system and user software. In at least one embodiment, each of the one or more processor cores 306 is configured to process a specific instruction set 308. In at least one embodiment, the instruction set 308 may facilitate Complex Instruction Set Computing (“CISC”), Reduced Instruction Set Computing (“RISC”), or computing via a Very Long Instruction Word (“VLIW”). In at least one embodiment, the processor cores 306 may each process a different instruction set 308, which may include instructions to facilitate emulation of other instruction sets. In at least one embodiment, the processor core 306 may also include other processing devices, such as a digital signal processor (“DSP”).

In at least one embodiment, each of the processor(s) 302 includes cache memory (“cache”) 310. In at least one embodiment, each of the processor(s) 302 can have a single internal cache or multiple levels of internal cache. In at least one embodiment, cache memory is shared among various components of each of the processor(s) 302. In at least one embodiment, a register file 312 is additionally included in each of the processor(s) 302 which may include different types of registers for storing different types of data (e.g., integer registers, floating point registers, status registers, and an instruction pointer register). In at least one embodiment, the register file 312 may include general-purpose registers or other registers.

In at least one embodiment, the processor(s) 302 are coupled with one or more interface bus(es) 314 to transmit communication signals such as address, data, or control signals between the processor(s) 302 and other components in processing system 300. In at least one embodiment, the interface bus(es) 314 can be a processor bus, such as a version of a Direct Media Interface (“DMI”) bus. In at least one embodiment, the interface bus(es) 314 is/are not limited to a DMI bus, and may include one or more Peripheral Component Interconnect (“PCI”) buses (e.g., PCI Express (“PCIe”) bus(es)), one or more memory buses, or other types of interface buses. In at least one embodiment, the processor(s) 302 include an integrated memory controller 316 and a platform controller hub (“PCH”) 318. In at least one embodiment, the memory controller 316 facilitates communication between a memory device 320 and other components of the processing system 300, while the PCH 318 provides connections to Input/Output (“I/O”) devices 322, such as a keyboard, mouse, data storage device, and display unit (not shown), and a network interface controller 324 (e.g., which may be implemented by the NIC 204) via a local I/O bus. In at least one embodiment, one or more PCI buses include PCIe Gen 5, which provides an interface for processors.

In at least one embodiment, the NIC 324 acts as the interface and controller for communication with other computing devices and/or network devices. In at least one embodiment, the NIC 324 is implemented with components illustrated in FIG. 2 with respect to the NIC 204. In at least one embodiment, the NIC 324 is implemented with components illustrated in the FIG. 1B with respect to the NIC 126. In at least one embodiment, the NIC 324 is coupled to a network device 326 (e.g., one of the GPU(s) 304 in another of the processor(s) 302 in a computer network). In at least one embodiment, the NIC 324 may be implemented using any hardware, software, and/or firmware. In at least one embodiment, at least a portion of the NIC 324 is implemented using at least a portion of any system(s) depicted in and/or described with respect to FIG. 1A-FIG. 9.

In at least one embodiment, the memory device 320 can be a dynamic random access memory (“DRAM”) device, a static random access memory (“SRAM”) device, flash memory device, phase-change memory device, or some other memory device having suitable performance to serve as processor memory. In at least one embodiment, the memory device 320 can operate as system memory for the processing system 300 that stores queue data 332 to enable communication between one or more of the processor(s) 302. In at least one embodiment, the memory controller 316 couples with the GPU(s) 304 of processor(s) 302 to perform graphics and media operations.

When one of the GPU(s) 304 in one of the processor(s) 302 initiates a communication with another of the processor(s) 302, a processor (e.g., the controller 134 of FIG. 1A or the processor 214 in the NIC 204 illustrated in FIG. 2) located in intermediate hardware (e.g., the intermediate hardware 124 and/or 210) handles the creation of the WQE and the processing of the CQE. In at least one embodiment, the intermediate hardware may be implemented as a DPA or a component of a DPA, and, in at least one embodiment, may be implemented as part of the NIC 324, the NIC 126 illustrated in FIG. 1A, or the NIC 204 illustrated in FIG. 2. In one embodiment, the processor located in the intermediate hardware may be implemented by a processor in one of the processor(s) 302 that is not a CPU processor core 306 or a GPU core of the GPU 304.

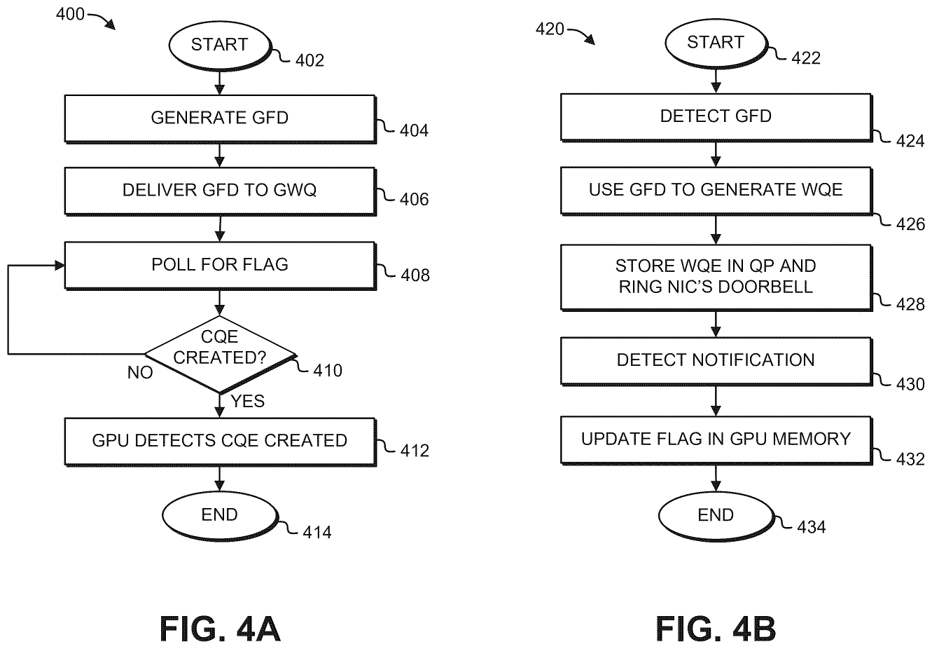

FIG. 4A is a flowchart illustrating a method 400 to be performed by a GPU, in accordance with at least one embodiment. The method 400 may be performed by one of the processor(s) 208 of the GPU 102. At a start 402, a processor (e.g., one of the processor(s) 208) of a GPU (e.g., the GPU 102) detects a request for communication (e.g., in a function, such as a CUDA kernel, being performed by the processor). In block 404, the processor of the GPU generates a GFD (e.g., the GFD 130) as part of an initial request to communicate. As noted above, the GFD includes all information necessary to create a WQE.

In block 406, the processor of the GPU delivers the GFD to (e.g., stores the GFD in) a GWQ assessable by a processor of intermediate hardware, such as the controller 134 of the intermediate hardware 124 and/or the processor 214 of the intermediate hardware 210 in the NIC 204. As noted above, notification of a new GFD is included in the GFD itself, thereby avoiding the GPU needing to ring a doorbell associated with the intermediate hardware (e.g., the intermediate hardware 124 or 210). For example, storing the GFD in the GWQ may cause the GWQ to notify the processor of the new GFD and/or the processor may poll the GWQ for new GFDs.

At this point, the intermediate hardware and/or a NIC (e.g., the NIC 126 or the NIC 204) may begin processing the GFD. When the NIC completes its processing, the NIC creates a CQE and stores the CQE in a CQ assessable by the processor of intermediate hardware. In response, the processor of intermediate hardware stores a completion indicator (e.g., a flag stored at a memory location identified by a designated completion address pointer) to indicate successful processing of the WQE to the processor of the GPU (e.g., to an application being performed by the processor that includes the function that caused the processor to generate the GFD).

In block 408, the processor of the GPU (e.g., the GPU 102) polls for a completion indicator (e.g., flag) stored in the designated address in GPU memory (e.g., the GPU memory 128) to detect whether a CQE has been created by the NIC and stored in the CQ in response to the GFD. At decision block 410, the processor of the GPU determines whether the completion flag indicates that the CQE has been created by the NIC. The decision is “YES” at decision block 410 when the processor of the GPU determines that the completion flag indicates the CQE has been created. Otherwise, the decision is “NO,” and the processor of the GPU returns to block 406 to poll again. When the decision is “YES” at block 412, the processor of the GPU detects that the NIC has created the CQE. The method 400 may end at 414.

FIG. 4B is a flowchart illustrating a method 420 to be performed by intermediate hardware, in accordance with at least one embodiment. The method 420 may be performed by the intermediate hardware 124 and/or the intermediate hardware 210. At a start 422, a GFD is waiting in the GWQ (e.g., blocks 404-406 of the method 400 (see FIG. 4A) may have been performed). At block 424, a processor (e.g., the controller 134 and/or the processor 214) of the intermediate hardware (e.g., the intermediate hardware 124 or 210) detects the GFD is waiting in the GWQ. As noted above, notification of a new GFD is included in the GFD itself, thereby avoiding any extra delay associate with ringing a doorbell associated with the intermediate hardware. For example, storing the GFD int the GWQ may cause the GWQ to notify the processor (e.g., the controller 134 and/or the processor 214) of the intermediate hardware of the new GFD and/or the processor may poll the GWQ for new GFDs.

The processor (e.g., the controller 134 and/or the processor 214) uses the GFD to create a WQE in block 426. In block 428, the WQE is delivered to or stored in a QP (e.g., the QP 138 or the QP 218) memory accessible to the processor of the intermediate hardware, and the processor of the intermediate hardware rings a doorbell associated with the NIC to notify the NIC of the newly created WQE. At this point, the NIC (e.g., the NIC 126 or the NIC 204) fetches the WQE and processes it. For example, the NIC may obtain data having a size indicated in the GFD and included in the WQE, from the source address indicted in the GFD and included in the WQE. Then, the NIC may transmit the data to a recipient device (e.g., a second processor 302 illustrated in FIG. 3) at the destination address indicted in the GFD and included in the WQE. In response to the data transmission, the recipient device will send an acknowledgement indicating that the transmission was received. The recipient device (e.g., the second processor) may perform one or more operations on the data received to produce a result. The NIC receives the acknowledgement from the recipient device (e.g., the second processor), creates the CQE, and stores the CQE in a CQ in memory accessible by the processor of the intermediate hardware.

Thus, after block 428, the processor of the intermediate hardware waits for the NIC to store the CQE in the CQ. At block 430, the processor of the intermediate hardware detects a notification from the NIC (e.g., sent in block 512 of a method 500) indicating that the NIC successfully processed the WQE. For example, if the NIC pushed a CQE to the CQ, at block 430, the processor of the intermediate hardware may detect the CQE has been stored in the CQ. By way of non-limiting examples, at block 430, the NIC may ring a doorbell associated with the processor of the intermediate hardware to indicate to the intermediate hardware that the CQE has been stored in the CQ, or the processor of the intermediate hardware may poll the CQ for new CQEs.

Next, at block 432, the processor of the intermediate hardware stores or updates a completion indicator (e.g., a flag stored at a memory location identified by a designated completion address pointer) to indicate successful processing of the WQE to the application running on the GPU 102. In at least one embodiment, at least one of blocks 408-412 of the method 400 may be performed after block 432. In at least one embodiment, the method 420 may be performed after blocks 406 of the method 400 and before block 412 of the method 400. The method 420 may end at 434.

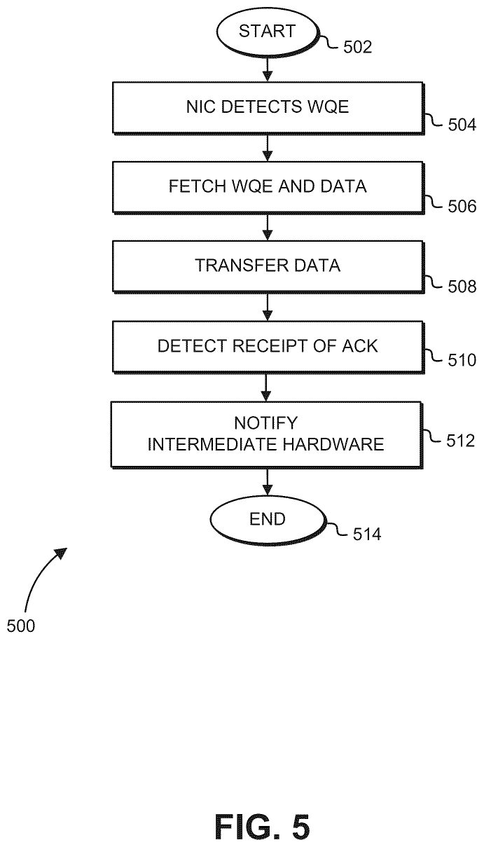

FIG. 5 is a flowchart illustrating a method 500 to be performed by a NIC, in accordance with at least one embodiment. By way of non-limiting examples, the method 500 may be performed by the NIC 126, the NIC 204, or the NIC 324. At a start 502, intermediate hardware (e.g., the intermediate hardware 124 or 210) has notified the NIC (e.g., rung a doorbell associated with the NIC) that a WQE is waiting in the QP to be processed (e.g., blocks 404-406 of the method 400 (see FIG. 4A) may have been performed, and/or blocks 424-428 of the method 420 (see FIG. 4B) may have been performed).

At block 504, WQE processing hardware (e.g., the WQE processing hardware 125) of the NIC detects that the WQE is waiting in the QP (e.g., in response to the notification from the intermediate hardware). The WQE processing hardware of the NIC may be implemented at least in part using any processing hardware, such as that described herein. By way of a non-limiting example, the WQE processing hardware of the NIC may be implemented at least in part using any device(s) suitable for implementing the processor 214.

At block 506, the WQE processing hardware of the NIC fetches the WQE and any data identified in the WQE to be transferred (e.g., identified by the source address and/or size provided in the GFD and included in the WQE). The WQE processing hardware of the NIC obtains the data in accordance with the WQE.

At block 508, the WQE processing hardware of the NIC uses the destination address included in the WQE (e.g., obtained from the GFD) to transmit or transfer the data to a recipient device (e.g., the recipient device 146) over a network (e.g., the network 150). After the recipient device receives that data, the recipient device sends an acknowledgement to the NIC.

At block 510, the WQE processing hardware of the NIC detects receipt of the acknowledgement (e.g., the ACK 152). Then, in response to receiving the acknowledgement, at block 512, the WQE processing hardware of the NIC notifies the intermediate hardware (e.g., the intermediate hardware 124 or 210) that the acknowledgement has been received. For example, at block 512, the WQE processing hardware of the NIC may notify the intermediate hardware by creating a CQE and pushing the CQE to a CQ (e.g., indicated by an identifier of the CQ included in the WQE) in memory accessible by the processor of the intermediate hardware (e.g., the intermediate hardware 124 or 210). In at least one embodiment, the method 500 may be performed after block 428 of the method 420 and before block 430 of the method 420. The method 500 may end at 514.

In at least one embodiment, referring to FIG. 1A, the creation of the WQE and/or processing of the CQE by a processor other than the GPU core(s) 122 improves operating efficiency of the GPU 102 in a networking environment.

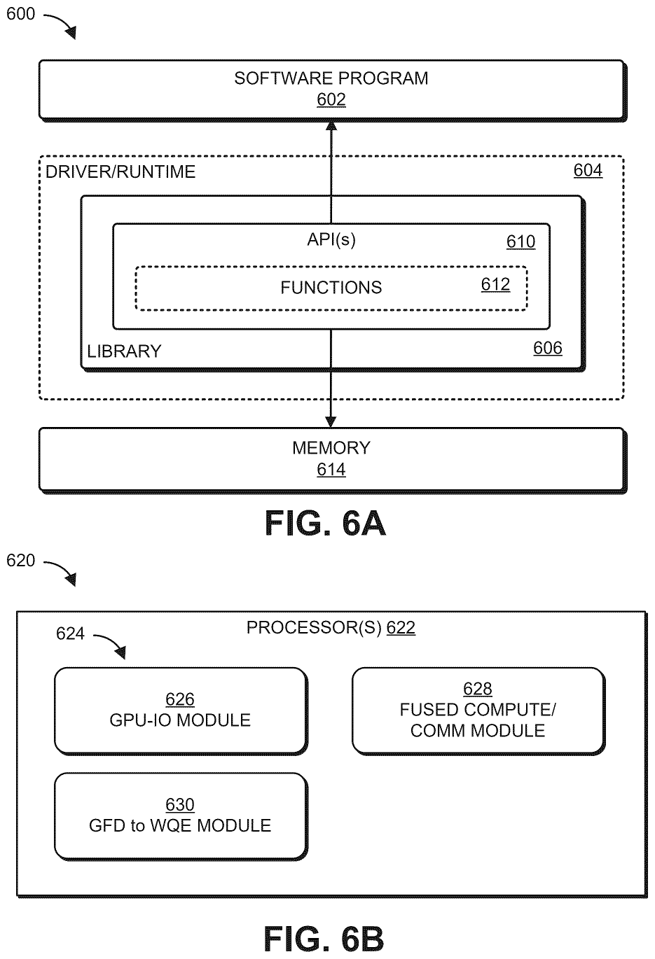

FIG. 6A illustrates an example of a system 600 that includes one or more drivers and/or one or more runtimes (illustrated as reference numeral 604) including one or more libraries 606 to provide one or more application programming interfaces (“API(s)”) 610, in accordance with at least one embodiment. In at least one embodiment, the system 600 includes the driver(s) 604 and/or the runtime(s) 604 including the library(ies) 606 to provide to the API(s) 610. In at least one embodiment, the API(s) 610 is/are sets of software instructions that, if executed, cause one or more processors (e.g., processor(s) 622 illustrated in FIG. 6B) to perform one or more computational operations. In at least one embodiment, one or more of the API(s) 610 is/are distributed or otherwise provided as a part of one or more of the library(ies) 606, one or more of the runtime(s) 604, one or more of the driver(s) 604, and/or one or more component of any other grouping of software and/or executable code further described herein. In at least one embodiment, one or more of the API(s) 610 perform one or more computational operations in response to invocation by one or more software programs 602.

In at least one embodiment, one or more of the software program(s) 602 is/are a software module and/or include(s) one or more software modules. In at least one embodiment, a software module is as further illustrated non-exclusively in FIG. 6B as one or more modules 624 and described with respect thereto. In at least one embodiment, one or more of the software program(s) 602 is/are a collection of software code, commands, instructions, and/or other sequences of text to instruct a computing device (e.g., the GPU 102) to perform one or more computational operations and/or invoke one or more other sets of instructions, such as the API(s) 610 or API function(s) 612, to be executed by the computing device. In at least one embodiment, functionality provided by one or more of the API(s) 610 includes the API function(s) 612, such as those usable to accelerate one or more portions of the software program(s) 602 using one or more parallel processing units (PPUs), such as GPUs (e.g., the GPU 102).

In at least one embodiment, one or more of the API(s) 610 is/are one or more hardware interfaces to one or more circuits to perform one or more computational operations. In at least one embodiment, one or more of the API(s) 610 described herein are implemented as one or more circuits to perform one or more techniques described in connection with FIGS. 1A-5. In at least one embodiment, one or more of the software program(s) 602 include instructions that, if executed, cause one or more hardware devices and/or circuits to perform one or more techniques further described in connection with FIGS. 1A-5. In at least one embodiment, the system 600 includes one or more or all components of the system 100 and/or one or more or all components of the system 200 described in relation to FIGS. 1B and 2, respectively, and the system 600 may perform one or more or all of the processes and/or operations that the systems and components of the system 100 and/or the system 200 perform.

In at least one embodiment, the software program(s) 602, such as user-implemented software programs, utilize one or more of the API(s) 610 to perform various computing operations, such as memory reservation, matrix multiplication, arithmetic operations, and/or any computing operation performed by PPUs, such as GPUs, as further described herein. In at least one embodiment, the function(s) 612 include a set of callable functions provided by one or more of the API(s) 610 that are referred to herein as APIs, API functions, software functions, and/or functions, that individually perform one or more computing operations, such as computing operations related to parallel computing. In at least one embodiment, one or more of the API(s) 610 perform interface operations of the GPU-IO 110, or GPU communications performed by the shared memory library 104 and/or the collective communications library 106 of FIG. 1B, and/or perform other operations described herein (e.g., in connection with FIGS. 1A-5).

In at least one embodiment, one or more of the software program(s) 602 interact or otherwise communicate with one or more of the API(s) 610 to perform one or more computing operations using one or more processors (e.g., processor(s) 622 illustrated in FIG. 6B), such as one or more PPUs, such as GPUs. In at least one embodiment, one or more computing operations using one or more PPUs include at least one or more groups of computing operations to be accelerated by execution at least in part by said one or more PPUs. In at least one embodiment, one or more of the software program(s) 602 interact with one or more of the API(s) 610 to perform interface operations of the GPU-IO 110, or GPU communications performed by the shared memory library 104 and/or the collective communications library 106 of FIG. 1B, and/or perform other operations described herein (e.g., in connection with FIGS. 1A-5).

In at least one embodiment, an interface is software instructions that, if executed, provide access to one or more of the function(s) 612 provided by one or more of the API(s) 610. In at least one embodiment, one or more of the software program(s) 602 use(s) a local interface when a software developer compiles one or more of the software program(s) 602 in conjunction with one or more of the library(ies) 606 including or otherwise providing access to one or more of the API(s) 610. In at least one embodiment, one or more of the software program(s) 602 is/are compiled statically in conjunction with one or more pre-compiled ones of the library(ies) 606 and/or uncompiled source code including instructions to perform one or more of the API(s) 610. In at least one embodiment, one or more of the software program(s) 602 are compiled dynamically and the dynamically compiled software program(s) utilize a linker to link to one or more pre-compiled ones of the library(ies) 606, including one or more of the API(s) 610.

In at least one embodiment, one or more of the software program(s) 602 use(s) a remote interface when a software developer executes a software program that utilizes or otherwise communicates with at least one of the library(ies) 606 including one or more of the API(s) 610 over a network or other remote communication medium. In at least one embodiment, one or more of the library(ies) 606 including one or more of the API(s) 610 are to be performed by a remote computing service, such as a computing resource services provider. In at least one embodiment, one or more of the library(ies) 606 including one or more particular APIs (of the API(s) 610) is/are to be performed by any other computing host providing the particular API(s) to one or more of the software program(s) 602.

In at least one embodiment, a processor (e.g., processor(s) 622 illustrated in FIG. 6B) performing or using one or more particular ones of the software program(s) 602 calls, uses, performs, and/or otherwise implements one or more of the API(s) 610 to allocate and otherwise manage memory 614 to be used by the particular software program(s). In at least one embodiment, one or more particular ones of the software program(s) 602 utilize one or more of the API(s) 610 to allocate and otherwise manage the memory 614 to be used by one or more portions of the particular software program(s) to be accelerated using one or more PPUs, such as GPUs, or any other accelerator or processor further described herein. In at least one embodiment, one or more of the software program(s) 602 request one or more neural networks to perform signal processing using one or more of the function(s) 612 provided by one or more of the API(s) 610. In at least one embodiment, the GPU memory 128 associated with the GPU 102, the memory 133, the memory 139, the memory 212 in the NIC 204, and/or the memory 224, implements memory 614.

In at least one embodiment, one or more of the API(s) 610 is an API to facilitate parallel computing. In at least one embodiment, one or more of the API(s) 610 is any other API further described herein. In at least one embodiment, one or more of the API(s) 610 is/are provided by one or more of the driver(s) 604 and/or one or more of the runtime(s) 604. In at least one embodiment, one or more of the API(s) 610 is/are provided by a CUDA user-mode driver. In at least one embodiment, one or more of the API(s) 610 is/are provided by a CUDA runtime. In at least one embodiment, one or more of the driver(s) 604 is/are data values and software instructions that, if executed, perform and/or otherwise facilitate operation of one or more of the function(s) 612 of one or more of the API(s) 610 during load and execution of one or more portions of at least one of the software program(s) 602. In at least one embodiment, one or more of the runtime(s) 604 is/are data values and/or software instructions that, if executed, perform or otherwise facilitate operation of one or more of the function(s) 612 of one or more of the API(s) 610 during execution of at least one of the software program(s) 602. In at least one embodiment, one or more particular ones of the software program(s) 602 utilize one or more of the API(s) 610 implemented and/or otherwise provided by one or more of the driver(s) 604 and/or one or more of the runtime(s) 604 to perform combined arithmetic operations by the particular software program(s) during execution by one or more PPUs, such as GPUs.

In at least one embodiment, one or more of the software program(s) 602 utilize one or more of the API(s) 610 provided by one or more of the driver(s) 604 and/or one or more of the runtime(s) 604 to perform combined arithmetic operations of one or more PPUs, such as GPUs. In at least one embodiment, one or more of the API(s) 610 provide combined arithmetic operations through one or more of the driver(s) 604 and/or one or more of the runtime(s) 604, as described above. In at least one embodiment, one or more of the software program(s) 602 utilize one or more of the API(s) 610 provided by one or more of the driver(s) 604 and/or one or more of the runtime(s) 604 to allocate or otherwise reserve one or more blocks of the memory 614 of one or more PPUs, such as GPUs. In at least one embodiment, one or more of the software program(s) 602 utilize one or more of the API(s) 610 provided by one or more of the driver(s) 604 and/or one or more of the runtime(s) 604 to allocate or otherwise reserve blocks of the memory 614.

In at least one embodiment, to improve usability of one or more particular ones of the software program(s) 602 and/or improve performance, one or more portions of the particular software programs are to be accelerated by one or more PPUs (such as GPUs). In at least one embodiment, one or more of the function(s) 612 receive one or more input parameters indicating one or more inputs to one or more neural networks and/or other data to be utilized by the neural network(s), such as one or more hyperparameters of the neural network(s). In at least one embodiment, the input parameter(s) include the one or more inputs and/or the other data. In at least one embodiment, the input parameter(s) include one or more pointers to one or more memory locations where the input(s) and/or the other data is/are stored.

In at least one embodiment, the system 600 includes at least one processor (e.g., processor(s) 622 illustrated in FIG. 6B) including one or more circuits to perform one or more software programs to combine two or more of the API(s) 610 into a single API. In at least one embodiment, the system 600 includes at least one processor (e.g., processor(s) 622 illustrated in FIG. 6B) that uses one or more of the API(s) 610 to perform interface operations of the GPU-IO 110, or GPU communications performed by the shared memory library 104 and/or the collective communications library 106 of FIG. 1B, and/or perform other operations described herein (e.g., in connection with FIGS. 1A-5).

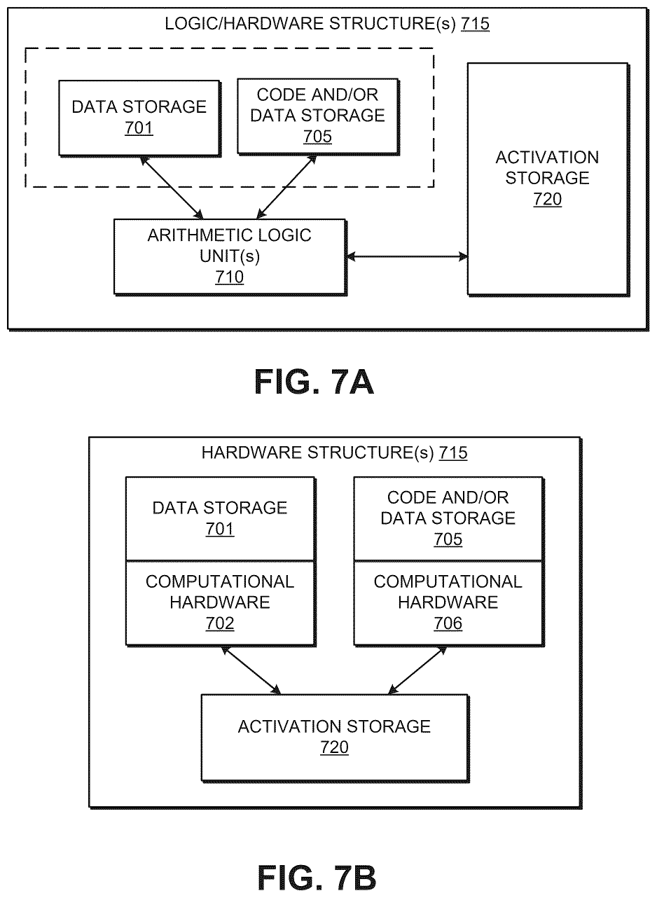

In at least one embodiment, the system 600 includes at least one processor (e.g., processor(s) 622 illustrated in FIG. 6B) that uses one or more of the API(s) 610 to perform one or more operations illustrated in and/or described with respect to one or more of FIGS. 1A-5, such as one or more processes illustrated in FIG. 5 or portion(s) thereof. In at least one embodiment, the system 600 includes at least one processor (e.g., processor(s) 622 illustrated in FIG. 6B) to perform one or more of the function(s) 612, such as those described in connection with FIGS. 1A-5. In at least one embodiment, one or more of the API(s) 610 is to be performed by hardware described in connection with FIGS. 7-9.

FIG. 6B is block diagram 620 illustrating example processor(s) 622 and the module(s) 624, according to at least one embodiment. Referring to FIG. 6B, in at least one embodiment, the processor(s) 622 may be implemented by the processor(s) 208 and 214 in FIG. 2. In at least one embodiment, the processor(s) 622 may perform one or more processes such as those described herein with respect to interface operations of the GPU-IO 110, or GPU communications performed by the shared memory library 104 and/or the collective communications library 106 of FIG. 1B, and/or perform other operations described herein (e.g., in connection with FIGS. 1A-5). In at least one embodiment, the processor(s) 622 perform(s) one or more processes such as those described in connection with FIG. 5.

In at least one embodiment, the processor(s) 622 include one or more processors such as those described in connection with FIGS. 1A-9. In at least one embodiment, processor(s) 622 may be any suitable processing unit and/or combination of processing units, such as one or more CPUs, GPUs, DPUs, GPGPUs, PPUs, and/or variations thereof. The processor(s) 622 includes the module(s) 624, which may include a GPU-IO module 626 to implement I/O/communications between the GPU 102 and one or more network devices 222. A fused compute/comm module 628 may implement a software kernel to perform data processing application and communications to generate a GFD. For example, the fused compute/comm module 628 may implement the fused compute and communications function(s) 108 and/or the method 400. Instructions included in the fused compute/comm module 628 may be performed by a processor (e.g., one of the processor(s) 208) of a GPU (e.g., the GPU 102). A GFD to WQE module 630 may include instructions to be implemented by intermediate hardware (e.g., the intermediate hardware 124 or 210) to create a WQE from the GPU-generated GFD (e.g., the GFD 116 in FIG. 1B). Instructions included in the GFD to WQE module 630 may implement the method 420. The module(s) 624 may be distributed among multiple processors that communicate over a bus, network, by writing to shared memory, and/or any suitable communication process such as those described herein. In at least one embodiment, the module(s) 624 may include processor executable instructions that implement the creation of a WQE from the GPU-generated GFD (e.g., the GFD 116 in FIG. 1B).

As used in any implementation described herein, unless otherwise clear from context or stated explicitly to contrary, a module refers to any combination of software logic, firmware logic, hardware logic, and/or circuitry configured to provide functionality described herein. Software may be embodied as a software package, code and/or instruction set or instructions, and “hardware,” as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. Modules may, collectively or individually, be embodied as circuitry that forms part of a larger system, for example, an integrated circuit (IC), system on-chip (SoC), and so forth. a module performs one or more processes in connection with any suitable processing unit and/or combination of processing units, such as one or more CPUs, GPUs, GPGPUs, DPUs, PPUs, and/or variations thereof.

In at least one embodiment, as used in any implementation described herein, unless otherwise clear from context or stated explicitly to contrary, terms such as “module” and nominalized verbs (e.g., image manager, image analyzer, analytics engine, controller, and/or other terms) each refers to any combination of software logic, firmware logic, hardware logic, and/or circuitry configured to provide functionality described herein. In at least one embodiment, software may be embodied as a software package, code and/or instruction set or instructions, and “hardware,” as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. In at least one embodiment, modules may, collectively or individually, be embodied as circuitry that forms part of a larger system, for example, an integrated circuit (IC), system on-chip (SoC), and so forth.

### Logic

FIG. 7A illustrates logic 715 which, as described elsewhere herein, can be used in one or more devices to perform operations such as those discussed herein in accordance with at least one embodiment. In at least one embodiment, logic 715 is used to perform inferencing and/or training operations associated with one or more embodiments. In at least one embodiment, logic 715 is inference and/or training logic. Details regarding logic 715 are provided below in conjunction with FIGS. 7A and/or 7B. In at least one embodiment, logic refers to any combination of software logic, hardware logic, and/or firmware logic to provide functionality or operations described herein, wherein logic may be, collectively or individually, embodied as circuitry that forms part of a larger system, for example, an integrated circuit (IC), system-on-chip (SoC), or one or processors (e.g., CPU, GPU).

In at least one embodiment, logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs)). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or including DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or including DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or including DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates logic 715, according to at least one embodiment. In at least one embodiment, logic 715 is inference and/or training logic. In at least one embodiment, logic 715 may include, without limitation, hardware logic in which computational resources are dedicated or otherwise exclusively used in conjunction with weight values or other information corresponding to one or more layers of neurons within a neural network. In at least one embodiment, logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, logic 715 illustrated in FIG. 7B may be used in conjunction with central processing unit (CPU) hardware, graphics processing unit (GPU) hardware or other hardware, such as field programmable gate arrays (FPGAs). In at least one embodiment, logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 includes one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in logic 715.

The GPU 102, the intermediate hardware 124, the intermediate hardware 210, the NIC 126, and/or the NIC 204 may implement the logic/hardware structures 715 of FIG. 7A. The GPU memory 128 and/or the shared memory library 104 may implement the data storage 701 and/or the code/data storage 705.

### Data Center

FIG. 8 illustrates an example data center 800, in which at least one embodiment may be used. In at least one embodiment, data center 800 includes a data center infrastructure layer 810, a framework layer 820, a software layer 830 and an application layer 840. Other functions, such as performed by the shared memory library 104, the collective communications library 106, fused compute and communications function(s) 108, and GPU-IO 110 operate within the GPU 102 to control network communications between the GPU and one or more of the network devices 222.

In at least one embodiment, as shown in FIG. 8, data center infrastructure layer 810 may include a resource orchestrator 812, grouped computing resources 814, and node computing resources (“node C.R.s”) 816(1)-816(N), where “N” represents a positive integer (which may be a different integer “N” than used in other figures). In at least one embodiment, node C.R.s 816(1)-816(N) may include, but are not limited to, any number of central processing units (“CPUs”) or other processors (including accelerators, field programmable gate arrays (FPGAs), graphics processors, etc.), memory storage devices 818(1)-818(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). In at least one embodiment, separate groupings of node C.R.s within grouped computing resources 814 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 812 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may utilize distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resources 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. In at least one embodiment, one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Logic 715 are used to perform inferencing and/or training operations associated with one or more embodiments. Details regarding logic 715 are provided herein in conjunction with FIGS. 7A and/or 7B. In at least one embodiment, logic 715 may be used in data center 800 for inferencing or predicting operations based, at least in part, on weight parameters calculated using neural network training operations, neural network functions and/or architectures, or neural network use cases described herein.

Data center operations, such as occur in the data center 800 involve frequent network communications between processors, such as the GPU 102, and one or more other network devices 222. GIN communications may be more efficiently executed by transferring the creation of a WQE from the GPU core(s) 122 to a separate processor (e.g., the controller 134 or the processor 214), separate hardware (such as the intermediate hardware 124 or 210), a CPU processor other than the processor cores 306, or to GPU hardware (e.g., a processor) other than the GPU core(s) 122. Greater GPU efficiency and reduced latency for communications between the GPU 102 and another network device (e.g., the network device 326) may be realized by not using the GPU core(s) 122 to generate WQEs.

### Computer Systems

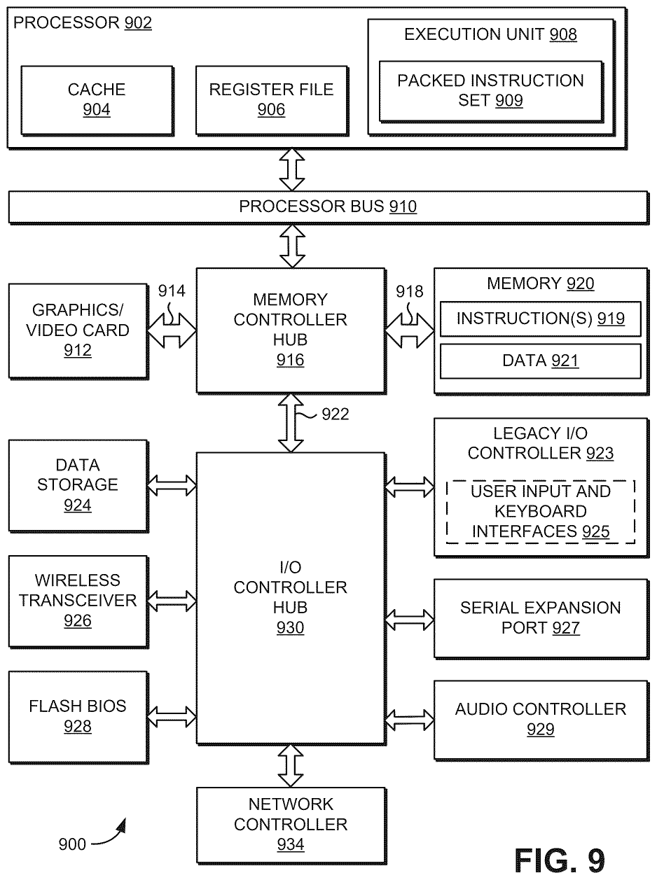

FIG. 9 is a block diagram illustrating an exemplary computer system, which may be a system with interconnected devices and components, a system-on-a-chip (SOC) or some combination thereof formed with a processor that may include execution units to execute an instruction, according to at least one embodiment. In at least one embodiment, a computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment, computer system 900 may be a multiprocessor system. In at least one embodiment, processor 902 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, a register file 906 may store different types of data in various registers including, without limitation, integer registers, floating point registers, status registers, and an instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor, along with associated circuitry to execute instructions, operations used by many multimedia applications may be performed using packed data in processor 902. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be a Dynamic Random Access Memory (“DRAM”) device, a Static Random Access Memory (“SRAM”) device, a flash memory device, or another memory device. In at least one embodiment, memory 920 may store instruction(s) 919 and/or data 921 represented by data signals that may be executed by processor 902.

In at least one embodiment, a system logic chip may be coupled to processor bus 910 and memory 920. In at least one embodiment, a system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O interface 922. In at least one embodiment, a system logic chip may provide a graphics port for coupling to a graphics controller. In at least one embodiment, MCH 916 may be coupled to memory 920 through high bandwidth memory path 918 and a graphics/video card 912 may be coupled to MCH 916 through an Accelerated Graphics Port (“AGP”) interconnect 914.

In at least one embodiment, computer system 900 may use system I/O interface 922 as a proprietary hub interface bus to couple MCH 916 to an I/O controller hub (“ICH”) 930. In at least one embodiment, ICH 930 may provide direct connections to some I/O devices via a local I/O bus. In at least one embodiment, a local I/O bus may include, without limitation, a high-speed I/O bus for connecting peripherals to memory 920, a chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as a Universal Serial Bus (“USB”) port, and a network controller 934. In at least one embodiment, data storage 924 may include a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary SoC. In at least one embodiment, devices illustrated in FIG. 9 may be interconnected with proprietary interconnects, standardized interconnects (e.g., PCIe) or some combination thereof. In at least one embodiment, one or more components of computer system 900 are interconnected using compute express link (CXL) interconnects.

Logic 715 are used to perform inferencing and/or training operations associated with one or more embodiments. Details regarding logic 715 are provided herein in conjunction with FIGS. 7A and/or 7B. In at least one embodiment, logic 715 may be used in computer system 900 for inferencing or predicting operations based, at least in part, on weight parameters calculated using neural network training operations, neural network functions and/or architectures, or neural network use cases described herein.

Network communications between processors, such as the GPU 102, and one or more other network devices 222 often involve network communications that are initiated by a GPU. GIN communications are more efficiently executed by transferring the creation of a WQE from the GPU core(s) 122 to separate hardware elements, such as a DPA in a NIC, a CPU processor other than the processor cores 306, or to GPU hardware other than the GPU core(s) 122. In at least one embodiment, hardware in the NIC 204 may implement the computer system 900. The additional processors, such as the controller 134 and/or the processor 214 may implement the processor 902. The memory 133, the memory 139, the memory 212, and/or the memory 224 may implement the memory 920 in FIG. 9. Various modules, such as the GFD to WQE module 630 may implement at least a portion of the instruction 919. Greater GPU efficiency and reduced latency for communications between the GPU 102 and another network device (e.g., the network device 326) may be provided by using the intermediate hardware (e.g., the intermediate hardware 124 or 210) to generate WQEs instead of the GPU core(s) 122.

At least one embodiment of the disclosure can be described in view of the following clauses:
1. A processor comprising one or more circuits to at least receive information from a graphics processing unit (GPU); use the information to generate a work queue element (WQE);
push the WQE to a work queue accessible by a network interface; and, upon completion of one or more operations identified in the WQE, set a value of a completion indicator in a local memory of the GPU.
2. The processor of clause 1, wherein the processor is comprised in the network interface.
3. The processor of clause 2, wherein the network interface comprises a network interface controller (NIC).
4. The processor of any of clauses 1 to 3, wherein the processor is comprised in a data-path accelerator (DPA).
5. The processor of any of clauses 1 to 4, wherein the network interface comprises a data-path accelerator (DPA).
6. The processor of any of clauses 1 to 5, wherein the processor is comprised in a data center, and the one or more operations identified in the WQE instructs the network interface to transmit data to a different processor in the data center.
7. The processor of any of clauses 1 to 6, wherein the information is to be received in a single communication from the GPU and generation of the WQE is initiated without additional communication from the GPU.
8. The processor of any of clauses 1 to 7, wherein the information is to include a GPU memory address pointer identifying a location in which the completion indicator is stored in the local memory of the GPU, and the one or more circuits are to use the GPU memory address pointer to set the value of the completion indicator.
9. The processor of any of clauses 1 to 8, wherein the information comprises a source address, a destination address, and an operation type.
10. A method comprising obtaining, by hardware other than a host central processing unit (CPU) or processing cores of a graphics processing unit (GPU), information generated by at least one of the processing cores of the GPU; generating, by one or more circuits of the hardware, a work queue element (WQE) based at least in part on the information; and storing, by the one or more circuits, the WQE in a work queue accessible by a network interface, to allow the network interface to perform one or more operations identified in the WQE.
11. The method of clause 10, further comprising, upon completion of the one or more operations identified in the WQE, setting, by the one or more circuits, a completion indicator in a local memory of the GPU.
12. The method of clause 11, wherein the information is to include a GPU memory location pointer to store an address of the completion indicator, and the one or more circuits are to use the GPU memory location pointer to set the completion indicator.
13. The method of any of clauses 10 to 12, wherein the information is received from the at least one processing core in a single network processing request.
14. The method of any of clauses 10 to 13, wherein the hardware comprises a data-path accelerator (DPA).
15. The method of any of clauses 10 to 14, wherein the hardware comprises a data-path accelerator (DPA) within at least one of the GPU or the network interface.
16. The method of any of clauses 10 to 15, wherein the network interface comprises a network interface controller (NIC).
17. A data center comprising first and second computing devices, the first computing device to comprise a host central processing unit (CPU); a graphics processing unit (GPU) comprising one or more processing cores, a particular processing core of the one or more processing cores to generate information related to a transfer of data to the second computing device; a communication processor other than the host CPU or any of the one or more processing cores, the communication processor to use the information to generate a work queue element (WQE), the communication processor to notify the particular processing core after a completion queue entry (CQE) is generated; and a network interface to perform the transfer of the data to the second computing device in accordance with the WQE, and to generate the CQE after an acknowledgement is received from the second computing device in response to the transfer.
18. The data center of clause 17, wherein notifying the particular processing core comprises setting a completion indicator in a local memory of the GPU.
19. The data center of clause 18, wherein the information is to include a GPU memory location pointer to store an address of the completion indicator, and the communications processor is to use the GPU memory location pointer to set the completion indicator.
20. The data center of any of clauses 17 to 19, wherein the particular processing core is to transmit the information to the communication processor in a single communication, and the communication processor is to generate the WQE in response to the single communication.
21. The data center of any of clauses 17 to 20, wherein the communication processor comprises a data-path accelerator (DPA).
22. The data center of any of clauses 17 to 21, wherein the communication processor is a component of at least one of the GPU or the network interface.

In at least one embodiment, a single semiconductor platform may refer to a sole unitary semiconductor-based integrated circuit or chip. In at least one embodiment, multi-chip modules may be used with increased connectivity which simulate on-chip operation, and make substantial improvements over utilizing a conventional central processing unit (“CPU”) and bus implementation. In at least one embodiment, various modules may also be situated separately or in various combinations of semiconductor platforms per desires of user.

In at least one embodiment, computer programs in form of machine-readable executable code or computer control logic algorithms are stored in main memory and/or secondary storage such as those described herein. Computer programs, if executed by one or more processors, enable at least one system described herein to perform various functions in accordance with at least one embodiment. In at least one embodiment, memory, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of a CPU such as those described herein, a parallel processing system such as those described herein, an integrated circuit capable of at least a portion of capabilities of both the CPU, the parallel processing system, a chipset (e.g., a group of integrated circuits designed to work and sold as a unit for performing related functions, etc.), and/or any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, a computer system described herein may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic. In at least one embodiment, a computer system includes or refers to any devices illustrated in any of the drawings and/or described herein.

In at least one embodiment, a parallel processing system includes, without limitation, a plurality of parallel processing units (“PPUs”) and associated memories. In at least one embodiment, PPUs are connected to a host processor or other peripheral devices via an interconnect and a switch or multiplexer. In at least one embodiment, a parallel processing system distributes computational tasks across the PPUs, which can be parallelizable—for example, as part of distribution of computational tasks across multiple graphics processing unit (“GPU”) thread blocks. In at least one embodiment, memory is shared and accessible (e.g., for read and/or write access) across some or all of the PPUs, although such shared memory may incur performance penalties relative to use of local memory and registers resident to a PPU. In at least one embodiment, operation of the PPUs is synchronized through use of a command such as __syncthreads( ), wherein all threads in a block (e.g., executed across multiple PPUs) to reach a certain point of execution of code before proceeding.

In at least one embodiment, one or more techniques described herein utilize a oneAPI programming model. In at least one embodiment, a oneAPI programming model refers to a programming model for interacting with various compute accelerator architectures. In at least one embodiment, oneAPI refers to an application programming interface (API) designed to interact with various compute accelerator architectures. In at least one embodiment, a oneAPI programming model utilizes a DPC++ programming language. In at least one embodiment, a DPC++ programming language refers to a high-level language for data parallel programming productivity. In at least one embodiment, a DPC++ programming language is based at least in part on C and/or C++ programming languages. In at least one embodiment, a oneAPI programming model is a programming model such as those developed by Intel Corporation of Santa Clara, CA.

In at least one embodiment, oneAPI and/or oneAPI programming model is utilized to interact with various accelerator, GPU, processor, and/or variations thereof, architectures. In at least one embodiment, oneAPI includes a set of libraries that implement various functionalities. In at least one embodiment, oneAPI includes at least a oneAPI DPC++ library, a oneAPI math kernel library, a oneAPI data analytics library, a oneAPI deep neural network library, a oneAPI collective communications library, a oneAPI threading building blocks library, a oneAPI video processing library, and/or variations thereof.

In at least one embodiment, a oneAPI DPC++ library, also referred to as oneDPL, is a library that implements algorithms and functions to accelerate DPC++ kernel programming. In at least one embodiment, oneDPL implements one or more standard template library (STL) functions. In at least one embodiment, oneDPL implements one or more parallel STL functions. In at least one embodiment, oneDPL provides a set of library classes and functions such as parallel algorithms, iterators, function object classes, range-based API, and/or variations thereof. In at least one embodiment, oneDPL implements one or more classes and/or functions of a C++ standard library. In at least one embodiment, oneDPL implements one or more random number generator functions.

In at least one embodiment, a oneAPI math kernel library, also referred to as oneMKL, is a library that implements various optimized and parallelized routines for various mathematical functions and/or operations. In at least one embodiment, oneMKL implements one or more basic linear algebra subprograms (BLAS) and/or linear algebra package (LAPACK) dense linear algebra routines. In at least one embodiment, oneMKL implements one or more sparse BLAS linear algebra routines. In at least one embodiment, oneMKL implements one or more random number generators (RNGs). In at least one embodiment, oneMKL implements one or more vector mathematics (VM) routines for mathematical operations on vectors. In at least one embodiment, oneMKL implements one or more Fast Fourier Transform (FFT) functions.

In at least one embodiment, a oneAPI data analytics library, also referred to as oneDAL, is a library that implements various data analysis applications and distributed computations. In at least one embodiment, oneDAL implements various algorithms for preprocessing, transformation, analysis, modeling, validation, and decision making for data analytics, in batch, online, and distributed processing modes of computation. In at least one embodiment, oneDAL implements various C++ and/or Java APIs and various connectors to one or more data sources. In at least one embodiment, oneDAL implements DPC++ API extensions to a traditional C++ interface and enables GPU usage for various algorithms.

In at least one embodiment, a oneAPI deep neural network library, also referred to as oneDNN, is a library that implements various deep learning functions. In at least one embodiment, oneDNN implements various neural network, machine learning, and deep learning functions, algorithms, and/or variations thereof.

In at least one embodiment, a oneAPI collective communications library, also referred to as oneCCL, is a library that implements various applications for deep learning and machine learning workloads. In at least one embodiment, oneCCL is built upon lower-level communication middleware, such as message passing interface (MPI) and libfabrics. In at least one embodiment, oneCCL enables a set of deep learning specific optimizations, such as prioritization, persistent operations, out of order executions, and/or variations thereof. In at least one embodiment, oneCCL implements various CPU and GPU functions.

In at least one embodiment, a oneAPI threading building blocks library, also referred to as oneTBB, is a library that implements various parallelized processes for various applications. In at least one embodiment, oneTBB is utilized for task-based, shared parallel programming on a host. In at least one embodiment, oneTBB implements generic parallel algorithms. In at least one embodiment, oneTBB implements concurrent containers. In at least one embodiment, oneTBB implements a scalable memory allocator. In at least one embodiment, oneTBB implements a work-stealing task scheduler. In at least one embodiment, oneTBB implements low-level synchronization primitives. In at least one embodiment, oneTBB is compiler-independent and usable on various processors, such as GPUs, PPUs, CPUs, and/or variations thereof.

In at least one embodiment, a oneAPI video processing library, also referred to as oneVPL, is a library that is utilized for accelerating video processing in one or more applications. In at least one embodiment, oneVPL implements various video decoding, encoding, and processing functions. In at least one embodiment, oneVPL implements various functions for media pipelines on CPUs, GPUs, and other accelerators. In at least one embodiment, oneVPL implements device discovery and selection in media centric and video analytics workloads. In at least one embodiment, oneVPL implements API primitives for zero-copy buffer sharing.

In at least one embodiment, a oneAPI programming model utilizes a DPC++ programming language. In at least one embodiment, a DPC++ programming language is a programming language that includes, without limitation, functionally similar versions of CUDA mechanisms to define device code and distinguish between device code and host code. In at least one embodiment, a DPC++ programming language may include a subset of functionality of a CUDA programming language. In at least one embodiment, one or more CUDA programming model operations are performed using a oneAPI programming model using a DPC++ programming language.

In at least one embodiment, any application programming interface (API) described herein is compiled into one or more instructions, operations, or any other signal by a compiler, interpreter, or other software tool. In at least one embodiment, compilation includes generating one or more machine-executable instructions, operations, or other signals from source code. In at least one embodiment, an API compiled into one or more instructions, operations, or other signals, when performed, causes one or more processors, such as graphics processors, graphics cores, parallel processor, a CPU, or any other logic circuit further described herein to perform one or more computing operations.

It should be noted that, while example embodiments described herein may relate to a CUDA programming model, techniques described herein can be utilized with any suitable programming model, such HIP, oneAPI, and/or variations thereof.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

In at least one embodiment, one or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor comprising:
one or more circuits to at least:
receive information from a graphics processing unit (GPU);
use the information to generate a work queue element (WQE);
push the WQE to a work queue accessible by a network interface; and
upon completion of one or more operations identified in the WQE, set a value of a completion indicator in a local memory of the GPU.

2. The processor of claim 1, wherein the processor is comprised in the network interface.

3. The processor of claim 2, wherein the network interface comprises a network interface controller (NIC).

4. The processor of claim 1, wherein the processor is comprised in a data-path accelerator (DPA).

5. The processor of claim 4, wherein the network interface comprises the DPA.

6. The processor of claim 1, wherein the processor is comprised in a data center, and the one or more operations identified in the WQE instructs the network interface to transmit data to a different processor in the data center.

7. The processor of claim 1, wherein the information is to be received in a single communication from the GPU and generation of the WQE is initiated without additional communication from the GPU.

8. The processor of claim 1, wherein the information is to include a GPU memory address pointer identifying a location in which the completion indicator is stored in the local memory of the GPU, and the one or more circuits are to use the GPU memory address pointer to set the value of the completion indicator.

9. The processor of claim 1, wherein the information comprises a source address, a destination address, and an operation type.

10. A method comprising:
obtaining, by hardware other than a host central processing unit (CPU) or processing cores of a graphics processing unit (GPU), information generated by at least one of the processing cores of the GPU;
generating, by one or more circuits of the hardware, a work queue element (WQE) based at least in part on the information; and
storing, by the one or more circuits, the WQE in a work queue accessible by a network interface, to allow the network interface to perform one or more operations identified in the WQE.

11. The method of claim 10, further comprising:
upon completion of the one or more operations identified in the WQE, setting, by the one or more circuits, a completion indicator in a local memory of the GPU.

12. The method of claim 11, wherein the information is to include a GPU memory location pointer to store an address of the completion indicator, and the one or more circuits are to use the GPU memory location pointer to set the completion indicator.

13. The method of claim 10, wherein the information is received from the at least one processing core in a single network processing request.

14. The method of claim 10, wherein the hardware comprises a data-path accelerator (DPA).

15. The method of claim 14, wherein the DPA is within at least one of the GPU or the network interface.

16. The method of claim 10, wherein the network interface comprises a network interface controller (NIC).

17. A data center comprising:
first and second computing devices, the first computing device to comprise:
a host central processing unit (CPU);
a graphics processing unit (GPU) comprising one or more processing cores, a particular processing core of the one or more processing cores to generate information related to a transfer of data to the second computing device;
a communication processor other than the host CPU or any of the one or more processing cores, the communication processor to use the information to generate a work queue element (WQE), the communication processor to notify the particular processing core after a completion queue entry (CQE) is generated; and
a network interface to perform the transfer of the data to the second computing device in accordance with the WQE, and to generate the CQE after an acknowledgement is received from the second computing device in response to the transfer.

18. The data center of claim 17, wherein notifying the particular processing core comprises setting a completion indicator in a local memory of the GPU.

19. The data center of claim 18, wherein the information is to include a GPU memory location pointer to store an address of the completion indicator, and the communications processor is to use the GPU memory location pointer to set the completion indicator.

20. The data center of claim 17, wherein the particular processing core is to transmit the information to the communication processor in a single communication, and the communication processor is to generate the WQE in response to the single communication.

21. The data center of claim 17, wherein the communication processor comprises a data-path accelerator (DPA).

22. The data center of claim 17, wherein the communication processor is a component of at least one of the GPU or the network interface.
